(19) United States
(12) Patent Application Publication
(10) Pub. No.: US 2004/0059835 A1
(43) Pub. Date: Mar. 25, 2004

(54) Method and system for in-band signaling between network nodes using state announcement or header field mechanisms

(76) Inventors: Zhigang Liu, Irving, TX (US); Narendra Chaparala, Richardson, TX (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/292,548

(22) Filed: Nov. 13, 2002

Related U.S. Application Data
(60) Provisional application No. 60/413,149, filed on Sep. 25, 2002.

(51) Int. Cl. G06F 15/16

(52) U.S. Cl. 709/247

(57) ABSTRACT

A method and system for in-band signaling between network nodes that uses a state announcement mechanism or a header field in a message to signal one of a plurality of possible events. A first network node containing a decompressor detects an event and assigns the detected event a state. The first network node assigns the state an identifier and transmits the identifier in-band to a second network node containing a compressor. The second network node processes the identifier to obtain the event. The first network node receives and de-compresses messages compressed and sent by the second network node. The in-band transmission uses a state announcement mechanism or a header field in a message between the second network node and the first network node to signal events.

This application claims the benefit of U.S. Provisional patent application Serial No. 60/413,149, filed Sep. 25, 2002, the contents of which is herein incorporated by reference in its entirety.

### BACKGROUND

1. Field of the Invention

The present invention relates to synchronization of compression states between a network node and another network node.

2. Description of the Related Art

The Jun. 4, 2002 Internet Engineering Task Force (IETF) publication entitled “Signaling Compression” by Richard Price, Carsten Bormann, Jan Christoffersson, Hans Hannu, Jonathon Rosenberg and the inventor, which is incorporated herein by reference in its entirety, discusses signaling compression (SigComp). The compression discussed therein is necessary to achieve call set up such as with the Session Initiation Protocol (SIP). The IETF SigComp specification provides very limited in-band signaling. In particular, the message format does not contain a field allowing one endpoint or network node (e.g., a decompressor) to signal to another endpoint or network node (e.g., a compressor) of a system failure. The system failure may cause loss of synchronization (e.g., loss of compression states) between the compressor and decompressor residing in two endpoints. The result is a deadlock scenario in which the remote endpoint is not aware of the de-synchronization and keeps sending compressed messages that cannot be decompressed by the malfunctioning endpoint.

Proposed solutions to the above deficiency of the IETF SigComp specification include: (1) sender retransmission and timeout, (2) signal the loss of synchronization outside of the SigComp specification (e.g., the application layer), and (3) use one of the current reserved bits in the SigComp message to carry the signal. However, each of these proposed solutions is problematic.

In looking at the first proposed solution, sender retransmission and timeout, usually, a signaling protocol has the request-response message sequence. If the sender has not received a response to a compressed message sent earlier after a timeout period, three things could have happened: (a) the compressed message is lost; (b) the compressed message reached the receiver but decompression failed due to loss of state synchronization; or (c) the response is lost. For the first N timeouts, where N is a number determined by implementation, the sender assumes the first or third case and retransmits the compressed message. However, if no response is received after N retransmissions, the sender assumes the second case and starts an appropriate recovery procedure. For instance, the sender can compress subsequent messages by using only a static dictionary that is guaranteed not to be lost or sending the subsequent messages uncompressed.

However, this solution introduces extra delay. One fundamental problem with attempt (1) is that the compressor cannot distinguish between case (a),(b) and (c). In the case when a loss of synchronization indeed has happened, the compressor still blindly performs N retransmissions (which are deemed to fail too) before realization it is in case (b) and takes recovery actions. The unnecessary delay is (N−1)* timeout. Note that setting N to 1 does not solve the problem either as that means every loss of a compressed message or corresponding response is incorrectly treated as a decompression failure. The consequence is a lower compression ratio, and thus higher transmission latency.

In the second proposed solution, signal the loss of synchronization outside of the SigComp specification (e.g., the application layer), not only is modification required but standardization of those modifications is also required. From this perspective, in-band signaling facilitates SigComp insertion into various protocol stacks.

In the third proposed solution, use one of the current reserved bits in the SigComp message to carry the signal, changes to the IETF SigComp specification are required. Also, there may be interoperability problems.

### SUMMARY OF THE INVENTION

A method and system for in-band signaling between network nodes that uses a state announcement mechanism or a header field in a message to signal one of a plurality of possible events. A first network node containing a decompressor detects an event and assigns the detected event a state. The first network node assigns the state an identifier and transmits the identifier in-band to a second network node containing a compressor. The second network node processes the identifier to obtain the event. The first network node receives and de-compresses messages compressed and sent by the second network node. The in-band transmission uses a state announcement mechanism or a header field in a message between the second network node and the first network node to signal the events.

### BRIEF DESCRIPTION OF THE DRAWING

The present invention is further described in the detailed description which follows in reference to the noted plurality of drawings by way of non-limiting examples of embodiments of the present invention in which the like reference numerals represent similar parts throughout the several views of the drawings and wherein:

FIG. 1 is a block diagram of a system for in-band signaling between network nodes according to an example embodiment of the present invention;

FIG. 2 is a flowchart of a process for using a state announcement mechanism according to an example embodiment of the present invention;

FIG. 3 is a diagram of a SigComp message with header fields according to an example embodiment of the present invention;

FIG. 4 is a flowchart of a process for using a SigComp message for in-band signaling according to an example embodiment of the present invention; and

FIG. 5 is a diagram of a mapping table according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e. the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phase “in one embodiment” in various places in the specification are not necessarily all referring to the same embodiment.

The present invention provides an in-band signaling mechanism for signaling compression (SigComp) by using the state announcement mechanism, such as, but not limited to, that provided in the above-referenced IETF SigComp specification, or by using an in-band signaling scheme using SigComp header fields. The in-band signaling can be used by a first network node (decompressor) receiving endpoint to inform a second network node (the compressor) transmitter peer about a loss of synchronization (e.g. due to system failure such as malfunction or memory corruption) and thus trigger an appropriate recovery procedure to achieve resynchronization of compression states between the decompressor at one endpoint and the compressor at a peer endpoint.

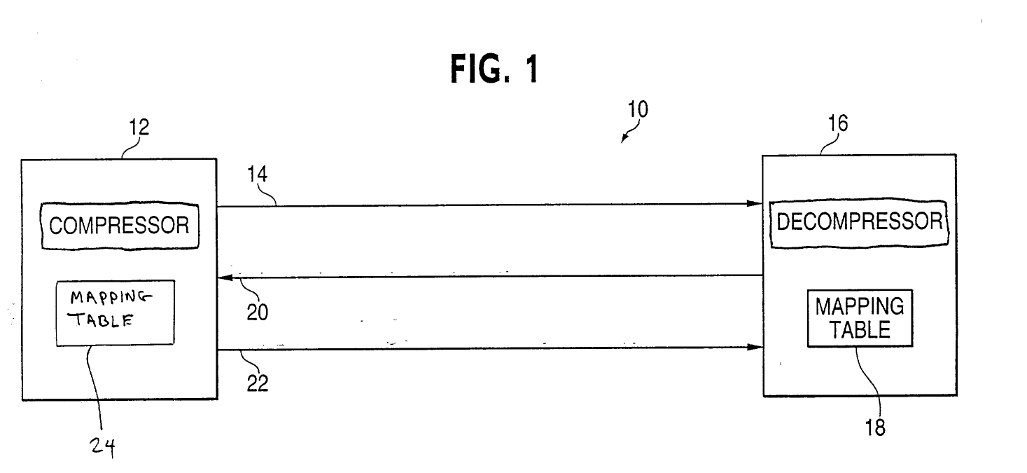

FIG. 1 shows a block diagram of a system for in-band signaling between network nodes that uses a state announcement mechanism or a header field in a message according to an example embodiment of the present invention. The system 10 includes a network node compressor (transmitter) 12 that makes transmissions 14 to another network node decompressor (receiver) 16. The network nodes may be wireless network nodes such as cellular phones or Personal Digital Assistants (PDAs). The compressor and decompressor may be part of applications located at the network nodes. The transmissions 14 may be compressed in accordance with any known prior art technique.

The decompressor at network node 16, upon detecting an event which is one of a plurality of possible events, may signal the event to its peer compressor at network node 12. The event may be any one of numerous occurrences at the decompressor at network node 16 including the detection of loss of synchronization.

A decompressor at network node 16 may map the detected event to a state according to a mapping table 18 stored locally at network node 16. The decompressor at network node 16 then may transmit in-band 20 an identifier of the mapped state to the peer compressor at network node 12. The compressor at network node 12 processes the received identifier of the mapped state to obtain the event occurring at the decompressor at network node 16. The processing may involve a mapping table 24 that is stored locally at network node 12. Thereafter, the compressor at network node 12 may take appropriate actions 22 in response to the event signalled by the decompressor at network node 16 including causing the decompressor to be resynchronized.

In one example embodiment of the present invention, a state announcement mechanism may be used. Using a state announcement mechanism according to the present invention, such as with using the IETF SigComp mechanism, allows a SigComp endpoint (decompressor) to announce its locally available state items to any remote endpoint (compressor). An endpoint may be one instance of an application, a SigComp layer, and a transport. The announcing endpoint may encode a list of partial state identifiers for those locally available state items as part of the “returned SigComp parameters” (See section 9.4.9 of the above-referenced IETF SigComp specification). A state identifier may be the (SHA-1) cryptographic hash calculated over the state item. When a remote endpoint compressor receives such an announcement, locally available state items may be used to compress messages sent to the announcing endpoint. This improves compression efficiency without actual uploading of state items, assuming that the content of the state items are known by the receiving endpoint out of band, e.g. pre-defined in a published document.

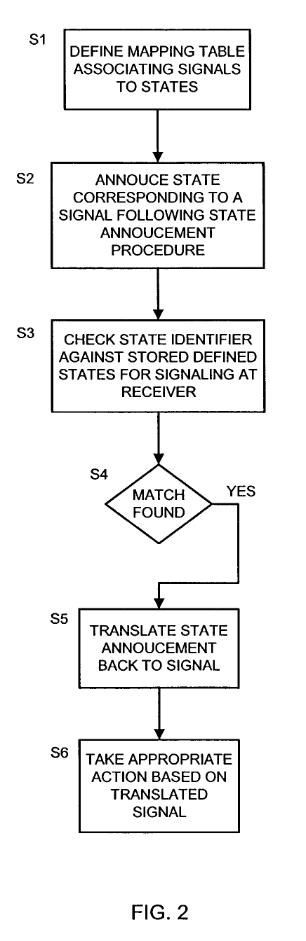

FIG. 2 shows a flowchart of a process for using a state announcement mechanism according to an example embodiment of the present invention. A mapping table is defined that associates a signal to a locally available state S1. The mapping table may be either standardized or implemented on proprietary basis. For example, to signal the event that all dynamic states are lost after a system malfunction, a state S may be defined containing the following string: “I crashed and lost all dynamic states”.

To send a signal, the sending endpoint simply announces the state corresponding to the signal following the state announcement procedure S2. In the above example an endpoint can announce state S after malfunction. When receiving a state announcement, the receiving endpoint checks the (partial) received state identifier against stored known states defined for signaling S3. If a match is found S4, the endpoint translates the state announcement back to the signal semantics it carries S5. The endpoint compressor may then take appropriate actions S6.

In the above example, when an endpoint compressor receives a state announcement corresponding to state S, the compressor knows the sending endpoint decompressor has malfunctioned and lost all its dynamic states. The compressor may, therefore, start a recovery procedure (e.g., sending message uncompressed or compressed but using only static dictionary).

In one example embodiment of the present invention, the invention may be applied in a standardized fashion (e.g., in 3GPP). In this example embodiment, the mapping table between locally available compressor states and signals may be standardized and the content of those locally available states are reserved. Every compressor endpoint understands the special meaning of those states or equivalently the meaning of the state identifiers of those states.

In another example embodiment of the present invention, the invention may be applied in a non-standardized fashion. In this example embodiment, the invention may be applied in a proprietary signal compressor implementation. In this embodiment, two groups of endpoints may be involved: one group of endpoints that implements the invention (referred to as “invention aware”) and another group of endpoints that does not (referred to as “invention unaware”). One advantage of the present invention is that no interoperability problem is introduced between these two groups. In particular, an invention unaware endpoint does not malfunction when receiving a signal sent by an invention aware endpoint. The invention unaware endpoint treats the state announcement as normal and tries to find the announced state. Of course the state is not found because the state is proprietary and not published. The invention unaware endpoint then ignores the state announcement.

However, there is a possibility that an invention unaware endpoint may accidentally have a locally available state that has the same content as that of a state used for signaling by an invention aware endpoint. Then, when the invention unaware endpoint sends a state announcement to the invention aware endpoint, the invention aware endpoint will mistakenly treat that announcement as an in-band signal that is actually not the intent of the invention unaware endpoint. This state content collision problem can be easily avoided by including a random number in the state for signaling. Since the probability that another endpoint generates the same random number independently decreases exponentially as the size of the random number grows, the size of random number (e.g., 10 bytes) can be adjusted to make the collision virtually impossible in practice. The issue is how to make the state content globally unique. Another issue is the state identifier collision, i.e., even if two states have different content, the hash over the two states might, in theory, yield the same state identifier. However, given two different states, the probability of state identifier collision is virtually zero (˜1/2\hat{ }80) due to the strong collision resistance property of SHA-1 hash. This is an issue intrinsic to SigComp and not specific to the present invention. The inclusion of a random number in a state to avoid state content collision can also be applied in the prior example embodiment (i.e., standardized case).

The mapping table may contain either the entire state (i.e., the content and the identifier of the state) for each signal, or only the state identifier (e.g., 20 bytes) for each signal. As long as the states in the table are not used for the purpose of compression, the latter approach may be advantageous since the size of the mapping table is reduced and thus the memory consumption is reduced for the in-band signaling mechanism (˜20 bytes per signal). This in-band signaling mechanism has good extensibility. New signals may be added simply by populating additional entries in the mapping table.

The overhead of the in-band signaling may be that of the state announcement. However, the latter is not always equal to the size of state identifier (e.g., 20 bytes). First, an announcing endpoint may send partial (e.g., first 6 bytes of) state identifier. Second, the announcing endpoint may not need to send any state identifier. All the announcing endpoint may need is to make the (partial) state identifier appear at the remote endpoint as part of the returned SigComp parameters (see section 9.4.9 of the above-identified IETF SigComp specification). This may be done, for example, by uploading bytecode to the remote endpoint. The bytecode may then parse each incoming SigComp message and generate the state identifier corresponding to a signal whenever seeing a bit at a predefined position in a message is set to 1. Thus, the overhead may be as low as one bit per signal. The overhead of the bytecode may be a one-time occurrence and may be amortized during the lifetime of the SigComp endpoint.

In another example embodiment of the present invention, header fields of a message may be used for in-band signaling of compression, e.g., SigComp header fields. SigComp is a standard currently developed in IETF and will be adopted by 3GPP Rel. 5 to compress SIP messages. Such compression may be necessary to achieve acceptable call set-up time. Although in-band signaling of compression is being used to illustrate the present invention, the present invention s not limited to this application of the present invention, as the present invention may be used to signal any type of event.

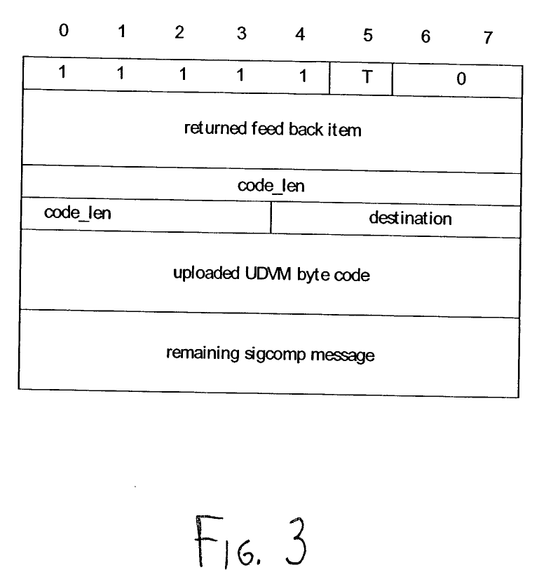

FIG. 3 shows a diagram of a SigComp message with header fields according to an example embodiment of the present invention. The 12 bit code_len field specifies the size of the uploaded UDVM byte code (from 0 to 4095) inclusive. The presence of code_len (bits 6 and 7 of the first byte in a SigComp message are set to zero) implies that the bytecode (i.e., instructions) required to decompress the compressed message is supplied as part of SigComp message. The destination field specifies the starting memory address in the UDVM buffer to which the bytecode is copied. According to the present invention, the code_len field and destination fields may be used to signal the events. By definition, code_len represents the length of byte code between 0 and 4095. If the length field is zero, then the SigComp message contains uploaded byte code length of 0 (effectively no code). When there's no uploaded byte code, there's no meaning for the destination field. Hence to signal an event, an endpoint may send SigComp message with code_len field set to 0. The destination field may be used to describe the type of the event. Since the destination field is 4 bits, 15 different types of events can be made possible (Destination value of 0 is reserved in SigComp). For example, to signal an event that the endpoint crashed and re-started (which usually means all dynamic states are lost), the SigComp message may set code_len to 0 and destination to 1. The sending endpoint on receiving this message assumes that the receiver has crashed and thus, the sender can take an appropriate action.

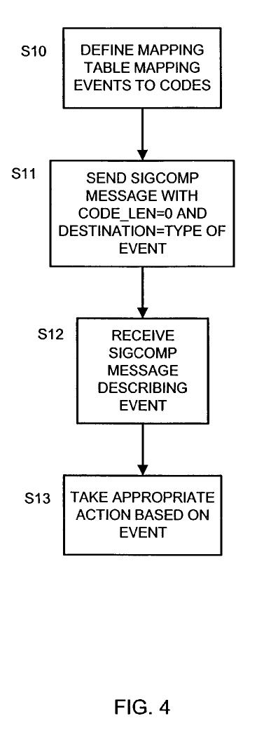

FIG. 4 shows a flowchart of a process for using a SigComp message for in-band signaling according to an example embodiment of the present invention. A mapping table is defined that maps the events and their corresponding 4-bit code S10. The mapping table may be either standardized or implemented on proprietary basis. The sending endpoint sends a signal by sending a SigComp message with code_len set to zero and destination field set to type of event S11. The receiving endpoint receives the SigComp message describing the event S12. After the receiving the SigComp message describing the event, the endpoint can take an appropriate action S13 (e.g start recovery procedure).

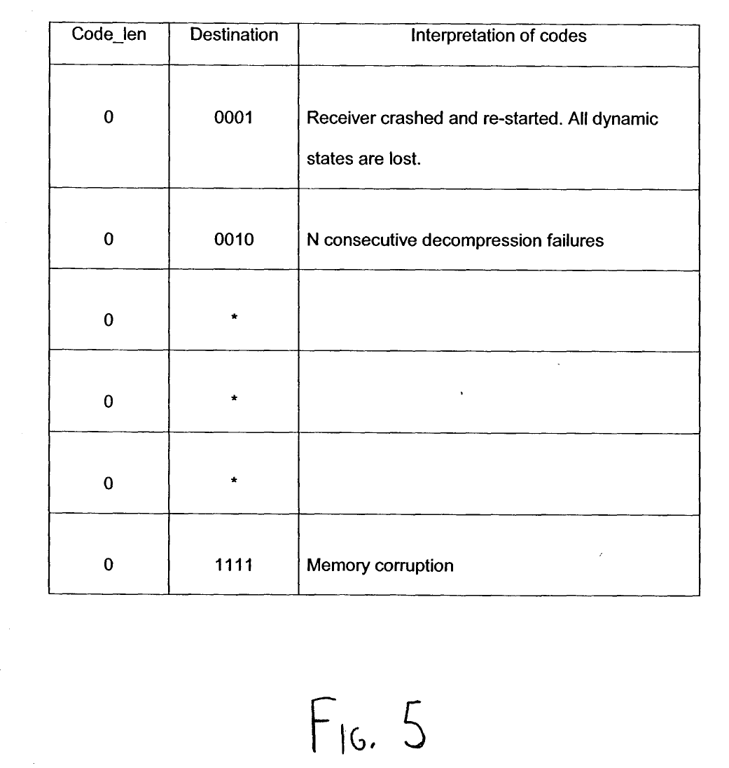

FIG. 5 shows a diagram of a mapping table according to an example embodiment of the present invention. In the mapping table, the Code_len field is set to a zero. The Destination field is then used to describe the type of the event. In this example embodiment, a destination field of 0001 represents an event where the receiver crashed and re-started and all dynamic states are lost. A destination field of 0010 represents an event where there have been N consecutive decompression failures detected. Further, a destination field of 1111 represents an event where there has been a memory corruption.

Similar to the embodiment of the present invention using the state announcement mechanism, an embodiment of the present invention using header fields of a message for in-band signaling of compression may be applied in either a standardized fashion or non-standardized fashion. Regarding use in a standardized fashion, e.g., standardized in 3GPP, the mapping table destination values may have to be standardized and every endpoint interprets the values in the same way and takes appropriate action. Regarding use in a non-standardized fashion, interoperability issues do not arise when invention is not standardized. The present invention can be implemented on proprietary basis or on a mutually agreed mapping table. In this case, as mentioned previously, there may be two kinds of endpoints, one that is invention aware and other that is not invention aware. The endpoint, which is not aware of the invention, will not malfunction when it receives a message from invention aware endpoint. However, the unaware endpoint may not take appropriate recovery procedures. Two administrative units may agree on the mapping table and appropriate recovery procedures if the two endpoints are in different administrative units and aware of invention.

According to the present invention, the mapping table may be extended to accommodate more events. For example, destination=1111 may be mapped to be an extension, indicating that the header is extended by ‘n’ number of bytes. These ‘n’ bytes may be used to indicate more events. However, one may not be able to use this extension unless the invention, including the extension, is standardized. Otherwise, there may be interoperability problems with endpoints that are not invention aware.

Method and system for in-band signaling between network nodes using state announcement or header field mechanisms according to the present invention are advantageous for a number of reasons. No extra delay is introduced as in current solutions. Moreover, in-band signaling according to the present invention avoids modifications to other layers/components outside of SigComp. Also, unlike prior art solutions, the present invention does not require changes to the IETF SigComp specification and has no interoperability problems. Thus, the present invention may be either applied in a proprietary implementation of SigComp or standardized (e.g. in 3GPP) as an extension to the IETF specification described previously.

In addition, method and system for in-band signaling between network nodes using state announcement or header field mechanisms according to the present invention are extensible. The present invention may be used to signal other events (other than signaling of synchronization loss between compressor and decompressor endpoints) by simply mapping each event to a locally available state. According to the present invention, signal semantics may be embedded in a state announcement, and more precisely, in a (partial) state identifier, or in a header message. Thus, a compressor may need to match a received state identifier against a stored table of state identifiers, such as, but not limited to, in a table before identifying the signal carried in the announcement or header. However, this is insignificant since the function of processing every received state identifier is required anyway in SigComp and since the occurrence of in-band transmission of the compression state should not happen often since normal usage is for abnormal events.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather the present invention extends to all functionally equivalent structures, methods and uses, such as are within the scope of the appended claims.

What is claimed is:

1. A method of signaling one of a plurality of possible events occurring in one network node to another network node comprising:
detecting an event at a first network node and assigning the detected event an identifier;
transmitting the identifier in-band to a second network node by the first network node; and
processing the identifier by the second network node to obtain the event.

2. The method according to claim 1, wherein the first network node receives and de-compresses messages compressed and sent by the second network node, the de-compressing being performed by a decompressor at the first node and the compression being performed by a compressor at the second node.

3. The method according to claim 1, further comprising:
detecting an event at a first network node and assigning the detected event a state; and
assigning the state the identifier by the first network node,
wherein the in-band transmission uses a state announcement mechanism between the second network node and the first network node.

4. The method according to claim 3, wherein the in-band transmission uses a state announcement mechanism present in a compression specification governing signaling of events between the second network node and the first network node.

5. The method according to claim 4, wherein the compression specification is an IETF specification.

6. The method according to claim 5, wherein the specification is defined in the Jun. 4, 2002 publication of the IETF entitled “Signaling Compression”.

7. The method according to claim 4, wherein the event is loss of synchronization between the second network node and the first network node.

8. The method according to claim 7, wherein the second network node takes action to cause the first network node to be resynchronized.

9. The method according to claim 8, wherein the action comprises a transmission of information from the second network node to the first network node.

10. The method according to claim 3, wherein the assigned state includes a random number, and the second network node processes the random number as part of detecting the event.

11. The method according to claim 1, wherein the transmissions involve the Session Initiation Protocol (SIP).

12. The method according to claim 1, wherein the in-band transmission uses a header field in a message between the first network node and the second network node.

13. The method according to claim 12, wherein the in-band transmission uses a header field present in a compression specification governing signaling of events between the first network node and the second network node.

14. The method according to claim 13, wherein the compression specification is an IETF specification.

15. The method according to claim 14, wherein the specification is defined in the Jun. 4, 2002 publication of the IETF entitled “Signaling Compression”.

16. The method according to claim 13, wherein the event is loss of synchronization between the second network node and the first network node.

17. The method according to claim 16, wherein the second network node takes action to cause the first network node to be resynchronized.

18. The method according to claim 17, wherein the action comprises a transmission of information from the second network node to the first network node.

19. The method according to claim 12, wherein a code_len field in the header is set to zero and a destination field in the header is set to the identifier representing the event.

20. The method according to claim 19, wherein the identifier in the destination field represents an extension indicating that the header is extended in size to indicate more events.

21. The method according to claim 19, wherein a mapping table is used that maps the identifiers to the events.

22. The method according to claim 21, wherein the mapping table is based on an industry standard.

23. The method according to claim 21, wherein the mapping table is proprietary.

24. A system for signaling one of a plurality of possible events comprising:
a first network node; and
a second network node, the second network node detecting an event and assigning the detected event an identifier, and
wherein the second network node transmits the identifier in-band to the first network node, the first network node processing the identifier to obtain the event.

25. The system according to claim 24, wherein the first network node receives and de-compresses messages compressed and sent by the second network node.

26. The system according to claim 24, wherein the second network node detects an event and assigns the detected event a state, and assigns the state the identifier, the in-band transmission using a state announcement mechanism between the second network node and the first network node.

27. The system according to claim 26, wherein the in-band transmission uses a state announcement mechanism present in a compression specification governing signaling of events between the second network node and the first network node.

28. The system according to claim 27, wherein the compression specification is an IETF specification.

29. The system according to claim 28, wherein the specification is defined in Jun. 4, 2002 publication of the IETF entitled “Signaling Compression”.

30. The system according to claim 27, wherein the event is loss of synchronization between the second network node and the first network node.

31. The system according to claim 30, wherein the second network node takes action to cause the first network node to be resynchronized.

32. The system according to claim 31, wherein the action comprises a transmission of information from the second network node to the first network node.

33. The system according to claim 27, wherein the assigned state includes a random number, and the second network node processes the random number as part of detecting the event.

34. The system according to claim 24, wherein the transmissions involve the Session Initiation Protocol (SIP).

35. The system according to claim 24, wherein the in-band transmission uses a header field in a message between the first network node and the second network node.

36. The system according to claim 35, wherein the in-band transmission uses a header field present in a compression specification governing signaling of events between the first network node and the second network node.

37. The system according to claim 36, wherein the compression specification is an IETF specification.

38. The system according to claim 37, wherein the specification is defined in the Jun. 4, 2002 publication of the IETF entitled “Signaling Compression”.

39. The system according to claim 36, wherein the event is loss of synchronization between the second network node and the first network node.

40. The system according to claim 39, wherein the second network node takes action to cause the first network node to be resynchronized.

41. The system according to claim 40, wherein the action comprises a transmission of information from the second network node to the first network node.

42. The system according to claim 35, wherein a code_len field in the header is set to zero and a destination field in the header is set to the identifier representing the event.

43. The system according to claim 42, wherein an identifier in the destination field represents an extension indicating that the header is extended in size to indicate more events.

44. The system according to claim 42, wherein a mapping table is used that maps the identifiers to the events.

45. The system according to claim 44, wherein the mapping table is based on an industry standard.

46. The system according to claim 44, wherein the mapping table is proprietary.
